(19) United States
(12) Patent Application Publication
(10) Pub. No.: US 2022/0261378 A1
(43) Pub. Date: Aug. 18, 2022

(54) INFORMATION PROCESSING APPARATUS, INFORMATION PROCESSING METHOD, AND NON-TRANSITORY COMPUTER READABLE MEDIUM

(71) Applicant: FUJIFILM Business Innovation Corp., Tokyo (JP)

(72) Inventors: Kengo TOKUCHI, Kanagawa (JP); Yuta NAKAMORI, Tokyo (JP)

(73) Assignee: FUJIFILM Business Innovation Corp., Tokyo (JP)

(21) Appl. No.: 17/387,323

(22) Filed: Jul. 28, 2021

(30) Foreign Application Priority Data
Feb. 18, 2021 (JP) 2021-024464

(51) Int. Cl. G06F 16/17; G06F 16/23; G06Q 30/06

(52) U.S. Cl. CPC G06F 16/1734; G06Q 30/0623; G06F 16/2358

(57) ABSTRACT

An information processing apparatus includes a processor configured to change a value of data in response to a usage log of the data.

### CROSS-REFERENCE TO RELATED APPLICATIONS

This application is based on and claims priority under 35 USC 119 from Japanese Patent Application No. 2021-024464 filed Feb. 18, 2021.

### BACKGROUND

### (i) Technical Field

The present disclosure relates to an information processing apparatus, an information processing method, and a non-transitory computer readable medium.

### (ii) Related Art

Japanese Unexamined Patent Application Publication No. 2014-174912 discloses a system that increases reliability of evaluation performed on posted content by an evaluator.

Japanese Unexamined Patent Application Publication No. 2012-141782 discloses a system that increases an incentive of an answerer by cooperating with an affiliate program.

Japanese Patent No. 6762057 discloses a system that regards, as a transaction content, posted by users via social networking service (SNS) and assures authenticity of the posted content while providing robustness to data tampering.

International Publication No. 2011/007721 discloses an apparatus that, when a product is purchased or a service is provided at user E-Commerce (EC) site, adds full reward to a poser database or an introducer database in accordance with a distribution ratio stored on an affiliate data service.

### SUMMARY

Aspects of non-limiting embodiments of the present disclosure relate to evaluating the value of data.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to change a value of data in response to a usage log of the data.

### BRIEF DESCRIPTION OF THE DRAWINGS

Exemplary embodiment of the present disclosure will be described in detail based on the following figures, wherein:

FIG. 1 is a block diagram illustrating a configuration of an information processing system of an exemplary embodiment;

FIG. 2 is a block diagram illustrating a configuration of a server;

FIG. 3 is a block diagram illustrating a configuration of a terminal apparatus;

FIG. 4 is a flowchart illustrating a process of the exemplary embodiment;

FIG. 5 illustrates usage log information;

FIG. 6 is a block diagram illustrating the server and terminal apparatuses; and

FIG. 7 is a block diagram illustrating the server and terminal apparatus.

### DETAILED DESCRIPTION

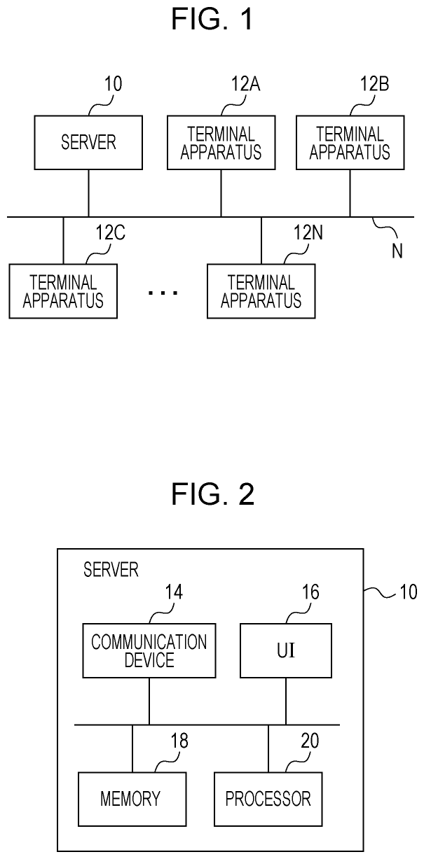

Referring to FIG. 1, an information processing system of an exemplary embodiment is described. FIG. 1 illustrates an example of a configuration of the information processing system of the exemplary embodiment.

The information processing system of the exemplary embodiment includes, for example, a server 10 and N terminal apparatuses (N is an integer of 1 or higher). Referring to FIG. 1, the information processing system of the exemplary embodiment includes terminal apparatuses 12A, 12B, 12C, . . . , 12N. The number of terminal apparatuses in FIG. 1 is illustrated for exemplary purposes only. The information processing system of the exemplary embodiment includes one or more terminal apparatuses. If the terminal apparatuses 12A, 12B, 12C, . . . , 12N are not differentiated from each other, each of these apparatuses is collectively referred to as a terminal apparatus 12. The information processing system of the exemplary embodiment may include another apparatus other than the server 10 and terminal apparatus 12.

The terminal apparatus 10 and each terminal apparatus 12 have a function of communicating with other apparatuses. The communication may be wired communication with cable and/or wireless communication. Specifically, each apparatus may be physically connected to another apparatus via a cable to exchange information. Each apparatus may transmit or receive information via wireless communication. The wireless communication may be near field communication or Wi-Fi (registered trademark). The near field communication may be Bluetooth (registered trademark), Radio Frequency Identifier (RFID), or NFC. Each apparatus may communicate with another apparatus via Local Area Network (LAN) and/or communication network N.

The server 10 provides online services via the communication network N. Users may utilize the online services using the terminal apparatus 12.

The online services include a service of providing an online storage, a service of providing an online meeting, a service of providing content online, a service of providing online games, a service of providing online shopping, social network service (SNS), or a combination two or more thereof. The online meeting may also be referred to as a web meeting, remote conference, or video conference. For example, the content may be an entertainment (such as a concert, theater, movie, video, or music), sports, or e-sports. Video distribution service and music distribution service is an example of the service providing the content online. The user may enjoy the entertainment online or view sports or e-sports.

The online service may or may not be a service that utilize virtual space. Virtual space is contrasted with real space. For example, examples of virtual space include virtual space implemented by a computer, virtual space on a network, such as the Internet, virtual space implemented by virtual reality (VR) technique, and cyber space. Virtual three-dimensional space and virtual two-dimensional space are also examples of the virtual space.

The server 10 may not necessarily provide the online service. The server 10 may receive and store data transmitted from the terminal apparatus 12 to the server 10. The server 10 may transmit data, transmitted from one terminal apparatus 12 to the server 10, to another terminal apparatus 12. The server 10 may transmit data stored thereon to the terminal apparatus 12. The server 10 may be a file server. The server 10 may have a function of constructing a database.

The terminal apparatus 12 may be a personal computer (PC), tablet PC, smart phone, wearable device (such as Augmented Reality (AR) glass, Virtual Reality (VR) glass, Mixed Reality (MR) glass, or bearable device), or mobile phone.

According to the exemplary embodiment, the value of data is changed in response to a usage log of the data. For example, the value of the data is determined based on the usage log of the data. An operation of determining the value of the data and an operation of changing the value of the data may be performed by the server 10 or the terminal apparatus 12. For example, when the data is transmitted, these processes may be performed by an apparatus serving as a transmission source of the data or an apparatus serving as a transmission destination.

The data is not limited to any particular data. For example, the data may be image data, video data, audio data (e.g., voice data or music data), character string data (e.g., a message), document data, drawing data, data concerning living things (e.g., a variety of data obtained from a living thing), data obtained from five senses (e.g., tactile data, taste data, or olfactory data), control data controlling a device, or a combination of two or more of these pieces of data. These pieces of data are quoted for exemplary purposes only. The data used in the exemplary embodiment may be data other than those pieces described above. The format of the data is not limited to any particular format. The data does not fall within the scope of the concept of programs.

The usage of data includes moving data, transmitting data, posting data, uploading data, receiving data, downloading data, acquiring data, copying data, editing data, and/or other operation or process performed on data.

Moving data includes moving data from one apparatus to another, from one recording medium to another, and/or from one folder to another.

Transmitting data includes transmitting data via an email, SNS, the Internet, and/or any other communication network.

Posting data includes posting data to SNS, web site (e.g., the video distribution site, music distribution site, or web site providing a bulletin board).

Uploading data includes uploading data to an online storage or an apparatus, such as a server.

Receiving data includes receiving data via email, SNS, the Internet, and/or any other communication network.

Downloading data includes downloading data via SNS or downloading data from web site, online storage, or apparatus, such as a server.

Data may be acquired via any method other than those described above.

Editing data includes modifying the contents of the data, deleting the contents of the data, and/or adding a new portion to the data. Example of editing data includes editing a document, image, video, and/or music.

Examples of the other operation or process include changing the name of data, compressing the data, decomposing the compressed data, encrypting data, decrypting the encrypted data, converting the format of data, partitioning data, and/or linking data.

The usage log of data includes the number of usages of data (all the number of usages of data, the number of usages of data during a specific period of time, or the frequency of usages), date of the usage of data, or a combination of two or more of these pieces of information. In addition, the usage log of data may include an operation, item, and contract related to the usage of data.

The data is linked to usage log information indicating the usage log of the data. When the data is used, the usage log information linked to the data is updated and information indicating the usage is thus included in the updated usage log information. For example, when the data is transmitted or posted, information indicating the transmission or the posting is included in the usage log information linked to the data. For example, the usage log information includes information indicating a transmission destination and a posting destination, information indicating the date of transmission or posting, information identifying a user who has transmitted or posted the data, and the like.

The usage log information is incidental to the data. If the data is moved, the usage log information is also moved together with the data.

As another operation example, the usage log information may be stored and managed in association with each piece of the data by a management apparatus, such as a server, and may thus not necessarily be moved together with the data.

The usage log of the data may be managed by using a technique of recording data in synchronization, like blockchain. In this way, the data may be strictly managed in a series of operations from creation all the way to distribution, discarding and deletion of the data.

The data may be linked to category information that is used to categorize the data. The category information is used to categorize the data and not limited to any type of information. For example, the category information includes information indicating the date of the creation of data, information indicating the update date of the data, information indicating the type of the data, information indicating the size of the data, information indicating the name of the data, information indicating the date of accessing the data, information indicating the genre, category, and field of the content represented by the data, information indicating the attribute of the creator of the data, information indicating the location where the data is created (e.g., country or region), or a combination of two or more of these pieces of information. The information indicating the attribute of the creator includes information identifying the creator (e.g., the name, user identification (ID), or account information), information indicating the sex of the creator, information indicating the age of the creator, information indicating the domicile or residence of the creator, information indicating the birthplace of the creator (e.g., country or region), information indicating the physical features of the creator, information indicating the hobby of the creator, information indicating the thought of the creator, information indicating the preference of the creator, or a combination of two or more of these pieces of information. The category information may be meta information or tag information incidental to the data. The category information may be used to search for the data. Using the category information, the data may be categorized or searched for.

The value of the data is determined based on the usage log of the data according to predetermined criteria. For example, as the number of usages of the data is higher, the value of the data is set to be lower. In other words, as the number of postings or transmissions of the data is lower, the value of the data is set to be higher. Specifically, as the number of postings or transmissions of the data is higher, the value of the data is decreased. The value of the data may be changed in a stepwise fashion. The value of the data may be changed depending on the user who is using the data, depending the transmission destination or posting destination when the data is transmitted or posted, or depending on the usage purpose of the data.

The value of the data may be changed in response to the type or manner of the usage of the data. Specifically, the degree of decrease in the value of the data may be different depending on the type or manner of the usage of the data. For example, the degree of decrease in the value of the data may be changed from when the data is transmitted, posted, or moved to when the data is copied. Specifically, the value of the data is decreased more when the data is transmitted, posted, or moved than when the data is copied. Conversely, the value of the data is decreased more when the data is copied than when the data is transmitted, posted, or moved.

The value of the data is represented by point, ranking, or amount of money. For example, the data having a higher number of points has a higher value. The data higher in ranking has a higher value. The data higher in the amount of money has a higher value. As the number of usages of the data is higher, the data has a lower ranking or a lower amount of money.

The value of the data may be changed depending on the compliance with contract terms until the data is acquired and provided. Specifically, the data may be illegally obtained or the data may not be linked to log information that proves that the data is obtained and managed after a contract for the data is legally concluded. In such a case, the value of the data may be decreased. As an amount of information proving legality of the data increases, the value of the data may be increased. If a deadline is specified in a contract, the value of the data may be set to be variable at the time when the value of the data is determined.

Value information indicating the value of data may be linked to the data. The value information may be included in the usage log information or category information. A person utilizing the data by referencing the value information may recognize the value of the data. For example, when the data is sold or purchased, a seller or purchaser recognizes the value information by referencing the value information linked to the data and determines the selling or purchasing price in accordance with the value of the data. The value may serve as a base for selling and purchasing negotiations.

Referring to FIG. 2, the hardware configuration of the server 10 is described below. FIG. 2 illustrates the hardware configuration of the server 10.

The server 10 includes, for example, a communication device 14, user interface (UI) 16, memory 18, and processor 20.

The communication device 14 is a communication interface including a communication chip and a communication circuit and has a function of transmitting or receiving information to and from another apparatus. The communication device 14 may have a wireless communication function and/or a wired communication function. The communication device 14 may communicate with another apparatus by using the near field communication or via a communication network N.

The UI 16 is a user interface and includes a display and/or an input device. The display is a liquid-crystal display or an electroluminescent (EL) display. The input device used may include a keyboard, mouse, input key, and/or operation panel. The UI 16 may be a touch panel serving as both the display and the input device.

The memory 18 includes one or more storage regions storing data. The memory 18 may be a hard disk drive (HDD), solid-state drive (SSD), a variety of memories (such as random-access memory (RAM) or read-only memory (ROM)), other storage device (such as an optical disk), or a combination thereof. The terminal apparatus 10 includes one or more memories 18.

The processor 20 is configured to control the operation of each element in the terminal apparatus 10. The processor 20 may include a memory. For example, the processor 20 may or may not provide a user with online services.

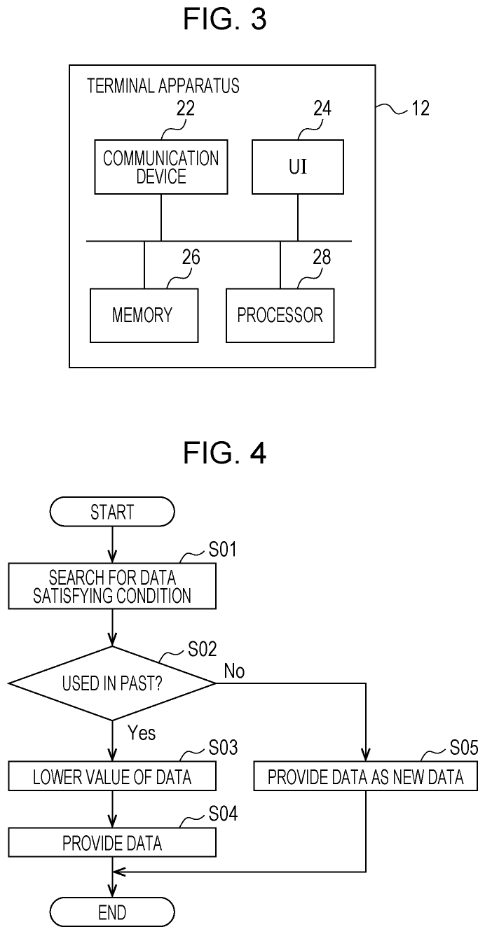

Referring to FIG. 3, the hardware configuration of the terminal apparatus 12 is described below. FIG. 3 illustrates an example of the hardware configuration of the terminal apparatus 12.

The terminal apparatus 12 includes a communication device 22, UI 24, memory 26, and processor 28.

The communication device 22 is a communication interface including a communication chip and a communication circuit and has a function of transmitting or receiving information to and from another apparatus. The communication device 22 may have a wireless communication function and/or a wired communication function. The communication device 22 may communicate with another apparatus by using the near field communication or via a communication network N.

The UI 24 is a user interface and includes a display and/or an input device. The display is a liquid-crystal display or an electroluminescent (EL) display. The input device used may include a keyboard, mouse, input key, and/or operation panel. The UI 24 may be a touch panel serving as both the display and the input device. The UI 24 may also include a microphone and/or a speaker. The terminal apparatus 12 may also include an imaging device, such as a camera.

The memory 26 includes one or more storage regions storing data. The memory 26 may be a hard disk drive (HDD), solid-state drive (SSD), a variety of memories (such as random-access memory (RAM) or read-only memory (ROM)), other storage device (such as an optical disk), or a combination thereof. The terminal apparatus 12 includes one or more memories 26.

The processor 28 is configured to control the operation of each element in the terminal apparatus 12. The processor 28 may include a memory.

The exemplary embodiment is described in detail below. The processor 20 in the server 10 or the processor 28 in the terminal apparatus 12 may perform the process of the exemplary embodiment or the processors 20 and 28 may cooperate with each other to perform the process of the exemplary embodiment. Part of the process may be performed by the processor 20 and the rest of the process may be performed by the processor 28. The server 10, the terminal apparatus 12, or a combination thereof is an example of an information processing apparatus of the exemplary embodiment.

Referring to FIG. 4, the process of the exemplary embodiment is described below. FIG. 4 is a flowchart illustrating the process. According to the exemplary embodiment, the value of data is changed in accordance with a usage log of the data. FIG. 4 illustrates the process to change the value of the data. The process in FIG. 4 is described for exemplary purposes only. The value of the data may be changed in accordance with the flow of a process other than the flow of the process described herein.

If a request to provide data satisfying a specific condition is issued, the data satisfying the specific condition is searched for (step S01). For example, if the server 10 requests the terminal apparatus 12A to provide data satisfying the specific condition, the processor 28 in the terminal apparatus 12A searches for the data satisfying the specific condition. The data may be stored on the terminal apparatus 12A or another apparatus other than the terminal apparatus 12A.

If the data satisfying the specific condition is searched for and found, the processor 28 determines whether the searched data is transmitted or posted in the past (step S02). For example, the processor 28 performs this determination operation by referencing the usage log information linked to the data.

If the found data is used in the past (yes path in step S02), the processor 28 in the terminal apparatus 12A decreases the value of the data (step S03) and provides a request source (e.g., the server 10) with the data (step S04). For example, the data is transmitted from the terminal apparatus 12A to the server 10, posted to SNS provided by the server 10, or uploaded to an online storage provided by the server 10. The operation of decreasing the value of the data may be performed by the request source (e.g., the server 10).

If the found data is not used in the past (no path in step S02), the processor 28 in the terminal apparatus 12A provides the request source (e.g., the server 10) with the data as new data (step S05). Specifically, the processor 28 in the terminal apparatus 12 provides the request source with the data with the value thereof not decreased.

A reward amount of the data may be determined based on the value of the data and the request source may pay the reward amount to a person who has provided the data.

The exemplary embodiment is described more in detail below.

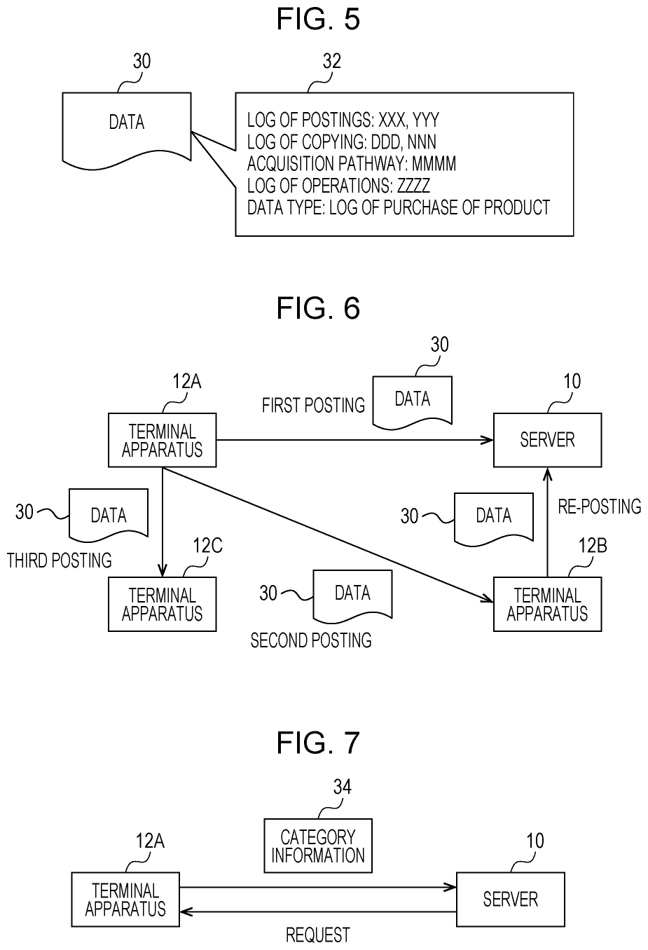

Referring to FIG. 5, an example of the usage log information is described. FIG. 5 illustrates the example of the usage log information.

Usage log information 32 is linked to data 30. Referring to FIG. 5, the usage log information 32 includes a log of postings of the data 30, information indicating a log of copying the data 30, a pathway used to acquire the data 30, a log of operations of the data 30, and the type of the data 30. The usage log information 32 in FIG. 5 are illustrated for exemplary purposes only. The usage log information 32 may include information used for another purposes. The usage log information 32 may not necessarily include all of the information in FIG. 5.

The usage log information 32 includes, as the log of postings of the data 30, information identifying a poster of the data 30 (e.g., a user having posted or a device used to post the data 30), information identifying a posting destination of the data 30 (e.g., a user or device as a posting destination, web site, or SNS), information indicating the date of posting, information identifying an application used to post the data 30 (e.g., application software used to use SNS), and information indicating the number of postings.

The usage log information 32 includes, as the log of copying of the data 30, information indicating the number of copying of the data 30, information identifying a user having copied the data 30, information identifying a device that has been used to copy the data 30, and other information.

The pathway used to acquire the data 30 is the Internet, SNS, email, or recording medium.

The usage log information 32 includes, as the log of operation of the data 30, information identifying the user having operated the data 30, information identifying a device used to operate the data 30, information indicating the contents of the operation, information indicating the date of operation of the data 30, and other information.

The category information used to categorize the data 30 may be linked to the data 30. FIG. 5 illustrates information indicating the type of data serving as the category information of the data 30. Although the usage log information 32 includes the information indicating the type of the data 30 herein, the information indicating the type of the data 30 may be linked to the data 30 separately from the usage log information 32. The category information excluding the information indicating the type of the data 30 may be linked to the data 30. Referring to FIG. 5, the type of the data 30 is a log of purchase of a product. In other words, the data 30 indicates the log of purchase of the product.

Referring to FIG. 6, the exemplary embodiment is specifically described. FIG. 6 illustrates the server 10, and terminal apparatuses 12A, 12B, and 12C.

The data 30 is stored on the memory 26 in the terminal apparatus 12A. A user A instructs the terminal apparatus 12A to post the data 30. For example, in response to the instruction of the user A, the terminal apparatus 12A posts the data 30 to the server 10 and terminal apparatuses 12B and 12C. Specifically, in response to the instruction from the user A, the data 30 is posted first from the terminal apparatus 12A to the server 10 (“first posting” in FIG. 6), posted from the terminal apparatus 12A to the terminal apparatus 12B subsequent to the first posting (“second posting” in FIG. 6), and posted from the terminal apparatus 12A to the terminal apparatus 12C subsequent to the second posting (“third posting” in FIG. 6). The usage log information 32 is transmitted together with the data 30 when the data 30 is posted. Referring to FIG. 6, the posting is described as an example of the usage of the data 30. The posting may be the transmission of data.

The processor 28 in the terminal apparatus 12A does not decrease the value of the data 30 at the first posting, decrease the value of the data 30 at the second posting by one notch in rank, and decreases the value the data 30 at the third posting by another notch in rank. If the value of data is represented by rank A, rank B, and rank C in the order of high to low rank, the value of the data 30 at the first posting is the rank A, the value of the data 30 at the second posting is the rank B lower than by one notch than the rank A, and the value of the data 30 at the third posting is the rank C lower than the rank B by one notch.

The processor 28 in the terminal apparatus 12A changes the value of the data 30 in response to the number of usages of the data 30 (e.g., the number of postings). Specifically, as the number of usages of the data 30 (e.g., the number of postings) increases, the processor 28 in the terminal apparatus 12A decreases the value of the data 30.

Moreover, if the first posting is performed, the processor 28 in the terminal apparatus 12A includes the information indicating the log of the first posting into the usage log information 32. For example, the processor 28 in the terminal apparatus 12A includes into the usage log information 32 information indicating that the number of usages of the data 30 (e.g., the number of postings) is one (the first posting), information indicating that the posting destination is the server 10, information indicating the date of the posting, and information indicating that the poster having posted the data 30 is the user A. Since the posting to the server 10 is the first posting, the processor 28 in the terminal apparatus 12A includes information indicating the value of the data 30 (e.g., information indicating the rank A) into the usage log information 32 without decreasing the value of the data 30. The usage log information 32 incidental to the data 30 is transmitted together with the data 30 to the server 10. For example, it is herein assumed that if the data 30 is posted to another apparatus, the data 30 remains stored on the terminal apparatus 12A. The data 30 stored on the terminal apparatus 12A is linked to the usage log information 32 reflecting the usage of the data 30.

When the second posting is performed after the first posting, the processor 28 in the terminal apparatus 12A includes the information indicating the log of the second posting into the usage log information 32. For example, the processor 28 in the terminal apparatus 12A includes into the usage log information 32 information indicating that the number of usages of the data 30 (e.g., the number of postings) is two (second usage), information indicating that the posting destination is the terminal apparatus 12B, information indicating the date of posting, and information indicating that the user having posted is the user A. Since the posting to the terminal apparatus 12B is the second posting, the processor 28 in the terminal apparatus 12A decreases the value of the data 30 by one notch and includes into the usage log information 32 information indicating the value of the data 30 (e.g., information indicating the rank B). The usage log information 32 incidental to the data 30 is transmitted together with the data 30 to the terminal apparatus 12B.

When the third posting is performed after the second posting, the processor 28 in the terminal apparatus 12A includes information indicating the log of the third posting into the usage log information 32. For example, the processor 28 in the terminal apparatus 12A includes into the usage log information 32 information indicating that the number of usages of the data 30 (e.g., the number of postings) is three (third usage), information indicating that the posting destination is the terminal apparatus 12C, information indicating the date of posting, and information indicating that the user having posted is the user A. Since the posting to the terminal apparatus 12C is the third posting, the processor 28 in the terminal apparatus 12A reduces the value of the data 30 by one notch and includes into the usage log information 32 information indicating the value of the data 30 (e.g., information indicating the rank C). The usage log information 32 incidental to the data 30 is transmitted together with the data 30 to the terminal apparatus 12C.

When the processor 28 in the terminal apparatus 12B having received the data 30 posts the data 30 to another apparatus (e.g., the server 10 in FIG. 6) (re-posting in FIG. 6), the processor 28 in the terminal apparatus 12B decreases the value of the data 30 by one notch and includes the information indicating the value of the data 30 (the information indicating the rank C) into the usage log information 32.

The value of the data 30 may be determined depending on the apparatus serving as the posting destination of the data 30. For example, the value of the data 30 may be determined whether the posting destination is the server 10, the terminal apparatus 12B, or the terminal apparatus 12C.

The reward amount of data may be determined based on the value of the data 30 and paid to a user who has provided the data. The reward amount is determined depending on the rank A, B, or C. The reward amount of the rank A is the highest, the reward amount of the rank B is the second highest, the reward amount of the rank C is the third highest, and so on.

A company may collect data by rewarding a user who has provided the data. The company collects the data by using the server 10 and rewards the user who has provided the data. Since the data 30 has the rank A at the first posting in FIG. 6, the user A having performed the first posting is rewarded with a reward amount corresponding to the rank A. The user A may be notified of the reward amount. Since the data 30 has the rank C in the re-posting, a user (e.g., a user B) having performed the re-posting is rewarded with a reward amount corresponding to the rank C. The reward amount corresponding to the rank C is lower than the reward amount corresponding to the rank A. In this way, as the number of usages of the data 30 (e.g., the number of postings) increases, the value of the data 30 is decreased and the reward amount provided to the user having provided the data 30 is also decreased.

Given the same number of postings, the processor 28 in the terminal apparatus 12A may make the value of the data 30 different from when the posting destinations are different to when the posting destinations are the same. For example, given the same number of postings, the processor 28 in the terminal apparatus 12A sets the value of the data 30 to be lower when the data 30 is posted to the same posting destination than when the data 30 is posted to different posting destinations. The processor 28 in the terminal apparatus 12A decreases the value of the data 30 by a larger extent of decrease in each posting when the posting destinations are the same than the positing destinations are different. Specifically, the data 30 may now have a rank A. If the data 30 is posted twice from the terminal apparatus 12A to the server 10, the data 30 is lowered to a rank D after the second posting. The data 30 is posted from the terminal apparatus 12A to the server 10 (the first posting) and then the data 30 is posted from the terminal apparatus 12A to the terminal apparatus 12B (the second posting). The data 30 is lowered to a rank C after the second posting. In this way, even when the data 30 is posted the same number of times, the value of the data 30 is changed depending on whether the posting destinations are the same or different.

The processor 28 in the terminal apparatus 12A may set the value of the data 30 to be different from when the data 30 is transmitted to mutually related multiple transmission destinations to when the data 30 is transmitted to mutually unrelated multiple transmission destinations. For example, the mutually related multiple transmission destinations are mutually competitive companies (e.g., companies having the same or similar business) and the mutually unrelated multiple transmission destinations are mutually uncompetitive companies (e.g., companies not having the same or similar business). The processor 28 in the terminal apparatus 12A decreases the value of the data 30 more when the data 30 is transmitted to the mutually related transmission destinations than when the data 30 is transmitted to the mutually unrelated transmission destinations. For example, the data 30 may now have the rank A and if the data 30 is transmitted to the mutually related transmission destinations, the processor 28 in the terminal apparatus 12A lowers the data 30 from the rank A to the rank C. If the data 30 is transmitted to the mutually unrelated transmission destinations, the processor 28 in the terminal apparatus 12A lowers the data 30 from the rank A to the rank B. For example, the value of the data 30 becomes lower when the same data 30 is transmitted to the mutually competitive multiple companies than when the data 30 is transmitted to the mutually uncompetitive multiple companies. In this case, as well, the value of the data 30 may be determined by an apparatus at the transmission destination of the data 30.

The processor 28 in the terminal apparatus 12A may change the value of the data 30 depending on a first transmission destination of the data 30. For example, if the data 30 has the rank A and the first transmission destination of the data 30 is a first company, the processor 28 in the terminal apparatus 12A lowers the data 30 from the rank A to the rank B. If the first transmission destination is a second company, the processor 28 in the terminal apparatus 12A lowers the data 30 from the rank A to the rank C. For example, the first company may be a small venture company and the second company may be a large-scale firm. The first company and second company may be determined by a user, an administrator of an information processing system, or a service provider (e.g., a company).

If the data 30 is re-transmitted after the data 30 is transmitted first, the user A having transmitted the data 30 first may be evaluated. For example, the user A may be rewarded. If the server 10 collects data, the processor 20 in the server 10 evaluates the user A who has transmitted first the data 30 and rewards the user A. This process is described with reference to FIG. 6. Referring to FIG. 6, the data 30 has been transmitted from the terminal apparatus 12A to the terminal apparatus 12B in response to an instruction from the user A. After that, the data 30 is transmitted from the terminal apparatus 12B to the server 10 in response to an instruction from the user B. The processor 20 in the server 10 evaluates the user A who has transmitted earlier (e.g., the user A who has transmitted first) and rewards the user A. Each time the data 30 is received, the processor 20 in the server 10 may evaluate the user A and reward the user A. The processor 28 in the terminal apparatus 12B having transmitted the data 30 to the server 10 may evaluate the user A and reward the user A.

The processor 28 in the terminal apparatus 12A may provide a request source with the category information in response to an acquisition request of the category information of the data 30. With the request source provided with the category information, the data 30 may be evaluated or a user having provided the category information (e.g., the user A) may be evaluated. Referring to FIG. 7, this process is described. FIG. 7 illustrates the server 10 and the terminal apparatus 12A. The processor 20 in the server 10 provides an acquisition request of the category information to the terminal apparatus 12A. The processor 28 in the terminal apparatus 12A receives the request and if the user A permits the category information to be provided, the processor 28 in the terminal apparatus 12A transmits to the server 10 category information 34 meeting the request. If the user A does not permit the category information to be provided, the processor 28 in the terminal apparatus 12A does not transmit the category information to the server 10. Referring to FIG. 7, the data 30 may be transmitted together with the category information 34 to the server 10 instead of being transmitted alone from the terminal apparatus 12A to the server 10. For example, if a request to acquire the category information indicating the type of the data 30 is provided and the user A permits the information to be provided, the processor 28 in the terminal apparatus 12A transmits to the server 10 the category information indicating the type of the data 30. The user A may permit part of the request and may not permit the rest of the request. For example, the processor 20 in the server 10 may request the terminal apparatus 12A to acquire information on multiple items included in the category information and the user A may permit part of the items to be acquired but may not permit the rest of the items to be acquired. The processor 28 in the terminal apparatus 12A transmits to the server 10 information corresponding to the items permitted by the user A out of the category information but does not transmit to the server 10 the items not permitted by the user A. The category information not published to other users may not necessarily be transmitted to the server 10.

The processor 20 in the server 10 having acquired the category information may evaluate the data 30 linked to the category information or the user A having provided the category information. For example, the processor 20 in the server 10 may increase the value of the data 30 linked to the category information or raise the value of the user A. In response to the value of the category information, the processor 20 in the server 10 may change the value of the data 30 or the value of the user A. For example, if an amount of the category information is larger (e.g., the number of items included in the category information is larger) or the category information is rarer, the processor 20 in the server 10 increase the value the data 30 or the user A. The processor 20 in the server 10 may fix the value of the category information. By increasing the value of the data 30 or the user A linked to the category information, the processor 20 in the server 10 may reward the user A in response to the increased value.

The processor 28 in the terminal apparatus 12A having transmitted the category information to the server 10 may evaluate the category information, the data 30, or the user A. The terminal apparatus 12 may acquire the category information from another terminal apparatus 12 or the server 10.

The processor 28 in the terminal apparatus 12A may change the value of the data 30 in response to the usage log of the data 30 and the usage purpose of the data 30. As described above, data has a higher value as the number of usages of the data (e.g., the number of postings) is smaller. Conversely, depending on the usage purpose of the data 30, the data 30 may have a higher value as the number of usages of the data (e.g., the number of postings) is larger. For example, the same data 30 is posted multiple times and as the number of postings increases, the value of the data 30 is estimated to be higher, and thus the value of the data 30 may be increased. The usage purpose may be determined depending on the user or company that is provided with the data 30. The same data 30 may now be posted multiple times to the server 10 employed by a company A. As the number of postings is larger, the value of the data 30 is higher for the company A depending on the usage purpose determined by the company A. In this case, the value of the data 30 is increased as the number of postings of the data 30 to the server 10 increases. The processor 28 in the terminal apparatus 12A may change the value of the data 30 or the processor 20 in the server 10 having received the data 30 may change the value of the data 30. Depending on the value, the user having provided the server 10 with the data 30 may be evaluated or thus rewarded. The user A having posted first the data 30 may be evaluated and rewarded. As the number of postings is higher, the user may be rewarded more.

The processor 28 in the terminal apparatus 12A may change the value of the data 30 depending on the attribute of a user having used the data 30. For example, when a user having much influence over other people utilizes the data 30, the processor 28 in the terminal apparatus 12A increases the value of the data 30 more than when a user having less influence over other people utilizes the data 30. For example, if the user A having more influence utilizes the data 30, the data 30 is set to a rank A and if a user B having less influence utilizes the data 30, the data 30 is lowered to a rank B. The influence may be determined by the server 10 that provides online service or depending on ratings over SNS.

The data 30 may be re-evaluated after the data 30 is evaluated for the first time. The data 30 may be re-evaluated in response to a request from a user who has provided the data 30 or in response to a request from a user who is provided with the data 30. The data 30 may be sold or purchased after the data 30 is evaluated. If an instruction to re-evaluate the data 30 is provided by a seller or purchaser, the data 30 is re-evaluated and the seller or purchaser is notified of the results of re-evaluation. The results of re-evaluation are used in the selling or purchasing negotiations of the data 30. A person not being satisfied with the value of the data 30 may possibly give an instruction to re-evaluate the data 30.

A user (e.g., the user A) having the data 30 that has been evaluated may be a seller of the data 30 and a purchaser of the data 30 may be another user or a company. If the user A as the seller considers that the data 30 is rated too low, the user A may possibly give an instruction to re-evaluate the data 30 using the terminal apparatus 12A. The purchaser may also possibly instruct the data 30 to be re-evaluated. If the instruction to re-evaluate the data 30 is provided, the processor 28 in the terminal apparatus 12A of the seller, the processor 20 in the server 10, or the processor 28 in the terminal apparatus 12 of the purchaser receives information concerning a proof provided by the seller or purchaser (e.g., information indicating the market trend serving as a criteria in the calculation of the present value, information indicating trading history of the data 30, or information indicating fluctuations of the value of data) and re-evaluates the value the data 30 in accordance with the information concerning the proof. The information concerning the proof may be sent to a negotiation partner via email or SNS. The seller and purchaser are notified of the results of the re-evaluation. For example, the information indicating the results of the re-evaluation is transmitted to the seller and purchaser and displayed on the display in the terminal apparatus 12 of each of the seller or purchaser. The seller and purchaser may negotiate the selling or purchasing of the data 30 by using the notified results of the re-evaluation as materials for the negotiation. If the sale is agreed between the seller and purchaser, the seller transmits the data 30 to the purchaser. If no sale is agreed, the data 30 is not transmitted from the seller to the purchaser. For example, the processor 20 in the server 10 provides the service to sell or purchase data and the seller and purchaser utilize the service by utilizing their own terminal apparatus 12. The data is thus sold and purchased. The server 10 may thus provide the service to mediate in the selling and purchasing of the data. If the sale is not completed, the seller and purchaser may provide information concerning a new proof and instruct the data 30 to be evaluated.

The sale of data has been described for exemplary purposes only. When a transaction other than selling and purchasing is performed, the data may be re-evaluated.

Each function of the server 10 and terminal apparatus 12 may be implemented, for example, by hardware cooperating with software. For example, each of the functions is implemented when the processor in each apparatus reads a program from the memory of the apparatus and executes the read program. The program is stored on the memory via a recording medium, such as a compact disk (CD) or digital versatile disk (DVD), or via a communication network.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
change a value of data in response to a usage log of the data.

2. The information processing apparatus according to claim 1, wherein the usage log is a number of usages of the data.

3. The information processing apparatus according to claim 2, wherein the processor is configured to decrease the value of the data as the number of usages of the data increases.

4. The information processing apparatus according to claim 1, wherein the processor is configured to change the value of the data in response to a status of contract fulfillment of the data.

5. The information processing apparatus according to claim 1, wherein usage of data is transmitting the data.

6. The information processing apparatus according to claim 2, wherein usage of data is transmitting the data.

7. The information processing apparatus according to claim 3, wherein usage of data is transmitting the data.

8. The information processing apparatus according to claim 4, wherein usage of data is transmitting the data.

9. The information processing apparatus according to claim 5, wherein the processor is configured to make the value of the data different from when the data is transmitted to a plurality of related transmission destinations to when the data is transmitted to a plurality of unrelated transmission destinations.

10. The information processing apparatus according to claim 6, wherein the processor is configured to make the value of the data different from when the data is transmitted to a plurality of related transmission destinations to when the data is transmitted to a plurality of unrelated transmission destinations.

11. The information processing apparatus according to claim 7, wherein the processor is configured to make the value of the data different from when the data is transmitted to a plurality of related transmission destinations to when the data is transmitted to a plurality of unrelated transmission destinations.

12. The information processing apparatus according to claim 8, wherein the processor is configured to make the value of the data different from when the data is transmitted to a plurality of related transmission destinations to when the data is transmitted to a plurality of unrelated transmission destinations.

13. The information processing apparatus according to claim 5, wherein the processor is configured to change the value of the data in response to a first transmission destination of the data.

14. The information processing apparatus according to claim 6, wherein the processor is configured to change the value of the data in response to a first transmission destination of the data.

15. The information processing apparatus according to claim 5, wherein if the data is further transmitted after the data is transmitted first, a user having transmitted the data first is evaluated.

16. The information processing apparatus according to claim 1, wherein the processor is configured to provide a request source with category information in response to a request to acquire the category information that is linked to the data and used to categorize the data.

17. The information processing apparatus according to claim 1, wherein the processor is configured to change the value of the data in response to the usage log of the data and a purpose of usage of the data.

18. The information processing apparatus according to claim 1, wherein if an instruction to re-evaluate the data is provided by a seller or a purchaser of the data when the data is sold or purchased after the value of the data is evaluated, the value of the data is re-evaluated and the seller or the purchaser is notified of results of the re-evaluation.

19. An information processing method comprising:
changing a value of data in response to a usage log of the data.

20. A non-transitory computer readable medium storing a program causing a computer to execute a process, the process comprising:
changing a value of data in response to a usage log of the data.
